(19) United States
(12) Patent Application Publication
(10) Pub. No.: US 2008/0199678 A1
(43) Pub. Date: Aug. 21, 2008

(54) Method for the Production of Vacuum Insulation Panels

(76) Inventors: Johann Klassen, Stemwede-Oppendorf (DE); Jorg Krogmann, Lohne (DE)

Correspondence Address: OBLON, SPIVAK, MCCLELLAND MAIER & NEUSTADT, P.C., 1940 DUKE STREET, ALEXANDRIA, VA, 22314, US

(21) Appl. No.: 11/913,795

(22) PCT Filed: May 8, 2006
(86) PCT No.: PCT/EP06/62136

§ 371 Date: Nov. 7, 2007

(51) Int. Cl. B32B 3/26; B32B 37/10

(52) U.S. Cl. 428/304.4; 156/286

(57) ABSTRACT

The invention relates to a process for producing vacuum insulation panels by envelopment of a shaped body comprising open-celled foam with a gastight film and subsequent evacuation and gastight welding shut of the films wherein the shaped body comprising open-celled foam is compressed after curing and before evacuation.

The invention relates to vacuum insulation panels, to a process for producing them and to open-celled rigid polyurethane foams which can be used as core material in vacuum insulation panels.

Vacuum insulation units are employed, inter alia, for refrigeration appliance housings, containers for refrigerated vehicles or district heating pipes. Owing to their low thermal conductivity, they offer advantages over conventional insulation materials. Thus, the energy saving potential compared to closed-celled rigid polyurethane foams is about 20-30%.

Such vacuum insulation units generally comprise a thermally insulating core material, for example open-celled rigid polyurethane (PUR) foam, open-celled extruded polystyrene foam, silica gels, glass fibers, beds of polymer, pressed milled rigid or semirigid PUR foam or Perlite, which is packed in a gastight film, evacuated and welded in so as to be airtight.

In a further embodiment, vacuum insulation units can be produced by introduction of a foam system for open-celled rigid polyurethane foams into the interior of the double wall of a double-walled housing, for example a refrigeration appliance door or a refrigeration appliance housing, where the system cures to give an open-celled foam, and subsequent evacuation. In this embodiment, a vacuum pump can be connected to the double wall filled with foam so that the vacuum can be restored if necessary.

When using rigid polyurethane foams, it is important that the cells of the foam are open in order to achieve complete evacuation of the vacuum insulation panel.

EP 905159 and EP 905158 disclose processes for producing open-celled rigid foams, in which an esterification product of fatty acids and polyfunctional alcohols is used as emulsifier to help maintain the storage-stable emulsion comprising blowing agent. In particular, combinations of perfluoroalkanes and alkanes are used as physical blowing agents. The use of perfluoroalkanes for producing fine cells is already known from EP 351 614.

The morphology of the cells of the open-celled rigid polyurethane foams used as core material also has a great influence on the thermal conductivity of the vacuum insulation panels.

Compressing open-celled rigid polyurethane foams during the foaming process for use as core material for vacuum insulation panels is known from EP 967 243. This occurs in two stages. Before the gel time of the foam, the latter is compressed to a volume of from 40 to 60% of the volume of the free-foamed foam and in a second stage during the rise time it is compressed to a volume of from 20 to 30% of the volume of the free-foamed foam.

This compression is intended to increase the content of open cells in the foam. The foams obtained in this way can be used for vacuum insulation panels having a reduced thermal conductivity. Disadvantages of this process are an increased density of the foam and also poorer demolding behavior as a result of the high compaction during the reaction phase. WO 99/36636 discloses a process for producing vacuum insulation panels, in which the panels are compressed during or after evacuation. This is said to achieve a reduction in the thermal conductivity and also a crease-free surface of the elements. A disadvantage is that the compression at this late stage can result in damage to the elements, in particular the weld. There is also a great danger that the compression will damage the film at the surfaces or particularly at the corners, for example by formation of small microcracks which can have an adverse effect on the life of the VIPs. In addition, an undesirable pressure increase occurs in the panel.

It was therefore an object of the present invention to develop vacuum insulation panels which are produced using open-celled foams as core material, are simple to produce and have a low thermal conductivity.

The invention accordingly provides vacuum insulation panels comprising a shaped body comprising open-celled foam which is packed in a gastight film, evacuated and welded in so as to be airtight, wherein the open-celled foam is compressed after curing and before evacuation.

The invention further provides a process for producing vacuum insulation panels by envelopment of a shaped body comprising open-celled foam with a gastight film and subsequent evacuation and gastight welding shut of the film, wherein the shaped body comprising open-celled foam is compressed after curing.

As foams, it is possible to use the open-celled foams customarily used for producing vacuum insulation panels. These are, for example, polystyrene foam, polyolefin foam such as polyethylene or polypropylene foam, polyacrylate foam, phenol-formaldehyde foams, polyvinyl chloride foam and, in particular, semirigid or rigid polyurethane foam, in particular rigid polyurethane foam.

The compaction, calculated as panel thickness before pressing:panel thickness after pressing, is preferably in the range from 2 to 3.8. A particularly low thermal conductivity is achieved at a compaction in the range from 3 to 3.5.

The terms compression and pressing are used synonymously in the following.

The pressing of the foam is, as described, carried out before evacuation of the vacuum insulation panel. In particular, pressing is carried out after shaping of the core for the vacuum insulation panel.

Pressing can preferably be carried out by means of a hydraulic or pneumatic press. Here, it has to be ensured, particularly when pressing is carried out after envelopment of the foam with the film, that no mechanical damage occurs. In particular, the surfaces of the pressing apparatus have to be very smooth and must have no sharp-edged or pointed unevennesses. The surface of the press should preferably be parallel to the surface of the body to be pressed.

The pressing procedure can, depending on the force applied, alter the orientation of the cells very greatly in the direction of an anisotropy right through to cell rupture. The length-width ratio of the foam cells is increased in the direction of the length until cell rupture finally occurs when the pressure is increased further.

The pressing procedure can be carried out in one or more stages. Pressing is preferably carried out in one stage.

The deterioration in the mechanical properties of the foams associated with the pressing of the foam can be tolerated, since vacuum insulation panels are generally not subject to great mechanical stress. It is more important for the application that they are dimensionally stable in use. The vacuum insulation panels of the invention fulfill this requirement. A further advantage of the process of the invention is that the property profile of the rigid foam is altered by the compression in the direction of greater flexibility, so that even nonplanar VIPs can be produced simply, for example for use in pipe insulation.

It is frequently the case that the thermal conductivity does not decrease with increasing compression. The thermal conductivity often goes through a minimum and then increases again as the compression increases. The optimum applicable to a particular type of foam can easily be determined by a person skilled in the art by means of preliminary tests. The compression frequently also depends on the required size of the component. In any case, the thermal conductivity of foams which have been subjected to pressing is lower than that of unpressed foams.

In principle, it is possible to use all previously described open-celled foams, in particular open-celled rigid polyurethane foams, for the vacuum insulation panels of the invention.

The open-celled rigid polyurethane foams are produced according to known processes by reaction of polyisocyanates with compounds having at least two hydrogen atoms which are reactive toward isocyanate groups.

As polyisocyanates, preference is given to using aromatic polyisocyanates, particularly preferably isomers of diphenylmethane diisocyanate (MDI) and mixtures of diphenylmethane diisocyanate and polyphenylenepolymethylene polyisocyanates (crude MDI).

As compounds having at least two hydrogen atoms which are reactive toward isocyanate groups, use is generally made of polyether alcohols and/or polyester alcohols.

The polyester alcohols are usually prepared by condensation of polyfunctional alcohols, preferably diols, having from 2 to 12 carbon atoms, preferably from 2 to 6 carbon atoms, with polyfunctional carboxylic acids having from 2 to 12 carbon atoms, for example succinic acid, glutaric acid, adipic acid, suberic acid, azelaic acid, sebacic acid, decanedicarboxylic acid, maleic acid, fumaric acid and preferably phthalic acid, isophthalic acid, terephthalic acid and the isomeric naphthalenedicarboxylic acids.

The polyester alcohols usually have a functionality of from 2 to 8, in particular from 4 to 8.

Particular preference is given to using polyether polyols, which are prepared by known methods, for example by anionic polymerization of alkylene oxides in the presence of alkali metal hydroxides, as polyhydroxyl compounds.

As alkylene oxides, preference is given to using ethylene oxide and 1,2-propylene oxide. The alkylene oxides can be used individually, alternately in succession or as mixtures.

Possible starter molecules are, for example: water, organic dicarboxylic acids such as succinic acid, adipic acid, phthalic acid and terephthalic acid, aliphatic and aromatic, optionally N-monoalkyl-, N,N- and N,N′-dialkyl-substituted diamines having from 1 to 4 carbon atoms in the alkyl radical, e.g. optionally monoalkyl- and dialkyl-substituted ethylenediamine, diethylenetriamine, triethylenetetramine, 1,3-propylenediamine, 1,3- or 1,4-butylenediamine, 1,2-, 1,3-, 1,4-, 1,5- and 1,6-hexamethylenediamine, aniline, phenylenediamines, 2,3-, 2,4-, 3,4- and 2,6-toluenediamine and 4,4′-, 2,4′- and 2,2′-diaminodiphenylmethane.

Further possible starter molecules are: alkanolamines such as ethanolamine, N-methylethanolamine and N-ethylethanolamine, dialkanolamines such as diethanolamine, N-methyldiethanolamine and N-ethyldiethanolamine and trialkanolamines such as triethanolamine and ammonia.

Further starter molecules used are polyhydric, in particular dihydric and/or trihydric, alcohols such as ethanediol, 1,2- and 1,3-propanediol, diethylene glycol, dipropylene glycol, 1,4-butanediol, 1,6-hexanediol, glycerol, pentaerythritol, sorbitol and sucrose, polyhydric phenols such as 4,4′-dihydroxydiphenylmethane and 2,2-bis(4-hydroxyphenyl)propane, resols such as oligomeric condensation products of phenol and formaldehyde and Mannich condensates of phenols, formaldehyde and dialkanolamines and also melamine.

The polyether polyols have a functionality of preferably from 2 to 8 and in particular from 3 to 6 and hydroxyl numbers of preferably from 120 mg KOH/g to 770 mg KOH/g and in particular from 240 mg KOH/g to 570 mg KOH/g.

The compounds having at least two hydrogen atoms which are reactive toward isocyanate groups also include the chain extenders and crosslinkers which may be used if appropriate. The addition of bifunctional chain extenders, trifunctional and higher-functional crosslinkers or, if appropriate, mixtures thereof can prove to be advantageous for modifying the mechanical properties. As chain extenders and/or crosslinkers, preference is given to using alkanolamines and in particular diols and/or triols having molecular weights of less than 400, preferably from 60 to 300.

If chain extenders, crosslinkers or mixtures thereof are employed for preparing the rigid foams based on isocyanate, they are advantageously used in an amount of from 0 to 20% by weight, preferably from 2 to 5% by weight, based on the weight of the compounds having at least two hydrogen atoms which are reactive toward isocyanate groups.

The process of the invention is usually carried out in the presence of blowing agents, catalysts and, if necessary, auxiliaries and/or additives.

As catalysts, it is possible to use the customary and known polyurethane catalysts. In particular, use is made of compounds which strongly accelerate the reaction of the isocyanate groups with the groups which are reactive toward isocyanate groups. Particular preference is given to using organic metal compounds, preferably organic tin compounds such as tin(II) salts of organic acids.

It is also possible to use strongly basic amines as catalysts. Examples are secondary aliphatic amines, imidazoles, amidines, triazines and alkanolamines.

The catalysts can, depending on requirements, be used either alone or in any mixtures with one another.

As blowing agent, preference is given to using water which reacts with isocyanate groups to eliminate carbon dioxide. In place of or preferably in combination with water, it is also possible to use physical blowing agents. These are compounds which are inert toward the starting components and are usually liquid at room temperature and vaporize under the conditions of the urethane reaction. The boiling point of these compounds is preferably below 110° C., in particular below 80° C. Physical blowing agents also include inert gases which are introduced into the starting components or dissolved in them, for example carbon dioxide, nitrogen or noble gases.

The compounds which are liquid at room temperature are usually selected from the group consisting of alkanes and cycloalkanes having at least 4 carbon atoms, dialkyl ethers, esters, ketones, acetals, fluoroalkanes having from 1 to 8 carbon atoms and tetraalkylsilanes having from 1 to 3 carbon atoms in the alkyl chain, in particular tetramethylsilane.

Examples which may be mentioned are propane, n-butane, isobutane and cyclobutane, n-pentane, isopentane and cyclopentane, cyclohexane, dimethyl ether, methyl ethyl ether, methyl butyl ether, methyl formate, acetone and also fluoroalkanes which can be degraded in the troposphere and therefore do not damage the ozone layer, e.g. trifluoromethane, difluoromethane, 1,1,1,3,3-pentafluorobutane, 1,1,1,3,3-pentafluoropropane, 1,1,1,2-tetrafluoroethane, difluoroethane and heptafluoropropane. The physical blowing agents mentioned can be used either alone or in any combinations with one another.

Auxiliaries and/or additives used are the materials which are known per se for this purpose, for example surface-active substances, foam stabilizers, cell regulators, fillers, pigments, dyes, flame retardants, hydrolysis inhibitors, antistatics, fungistatic and bacteriostatic agents.

Further information on the starting materials, blowing agents, catalysts and auxiliaries and/or additives used for carrying out the process of the invention may be found, for example, in Kunststoffhandbuch, Volume 7, “Polyurethane” Carl-Hanser-Verlag Munich, 1st edition, 1966, 2nd edition, 1983, and 3rd edition, 1993.

To produce the rigid foams based on isocyanate, the polyisocyanates a) and the compounds having at least two hydrogen atoms which are reactive toward isocyanate groups b) are reacted in such amounts that the equivalence ratio of NCO groups of the polyisocyanates a) to the sum of the reactive hydrogen atoms of the components b) is 0.85-1.75:1, preferably 1.0-1.3:1 and in particular about 1.0-1.15:1. If the foams comprising urethane groups are modified by formation of isocyanurate groups, for example to increase the flame resistance, a ratio of NCO groups of the polyisocyanates a) to the sum of the reactive hydrogen atoms of the component b) of 1.6-60:1, preferably 3.0-8:1, is usually employed.

The rigid foams based on isocyanate can be produced batchwise or continuously by the prepolymer process or preferably by the one-shot process with the aid of known mixing apparatuses.

It has been found to be particularly advantageous to employ the two-component process and combine the compounds having at least two hydrogen atoms which are reactive toward isocyanate groups with the blowing agents, the catalysts and the auxiliaries and/or additives to form a polyol component and react this with the polyisocyanates or mixtures of the polyisocyanates and, if appropriate, blowing agents, also referred to as isocyanate component.

The vacuum insulation panels can be produced in various shapes, for example as simple panels or with other, nonplanar geometries. Their production and the materials which can be used are known per se. It is usual to weld in a getter material together with the core materials in order to prevent the vacuum from being adversely affected by volatile substances which outgas later.

A film is generally used as enveloping material for the vacuum insulation panels. Preferred films are composite films, in particular multilayer composite films having a vapor deposited or laminated metal layer, for example of aluminum. Suitable films comprise, for example, polyester, polyvinyl chloride, polyolefins such as polyethylene or polypropylene, or polyvinyl alcohol. Further possible enveloping materials are, for example, inliners of refrigerators, pipe sheathing or metal layers.

In the production of vacuum insulation panels using the rigid polyurethane foams produced according to the invention, the foam is firstly produced in a manner known per se. The foams obtained are then, if they have not already been produced as appropriate shaped bodies, brought to the shape which they have as core of the vacuum insulation panel. This is preferably achieved by parting, in particular sawing, into appropriate slab sizes. In parting, the foam is, in particular, parted parallel to the foaming direction, since the resulting slab then has a lower thermal conductivity as a result of the anisotropy of the foams. The shaped bodies are then packed in the gastight envelope, preferably the composite film, evacuated and welded shut so as to be gastight.

The vacuum insulation panels produced by the process of the invention can be used for the insulation of refrigeration appliances, containers and buildings and also for the sheathing of pipes. Owing to their flexibility, they can easily be deformed, which is particularly advantageous when they are used as pipe sheathing.

The invention is illustrated by the following examples.

### EXAMPLES 1 TO 3 AND COMPARATIVE EXAMPLE

A block of rigid polyurethane foam having the thickness indicated in the table is compressed to the thickness indicated in the table by means of a hydraulic press and the thermal conductivity in the direction of compression is determined. The results are likewise shown in the table.

| | Exam- | | | Comparative | |
|---|---|---|---|---|---|
| | ple 1 | Example 2 | Example 3 | example | Unit |
| Foam | I | I | II | I | |
| Density | 40 | 40 | 60 | 40 | kg/m³ |
| before | | | | | |
| pressing | | | | | |
| Thickness | 30 | 36 | 30 | 30 | mm |
| without | | | | | |
| pressing | | | | | |
| TC without | 8.4 | 8.5 | 8.5 | 8.5 | mW/mK |
| pressing | | | | | |
| 1st pressing: | 20 | 18 | 11 | | mm |
| thickness/TC | 6.5 | 6.1 | 6.5 | | mW/mK |
| 2nd pressing: | 10 | | | | mm |
| thickness/TC | 5.5 | | | | mW/mK |
| 3rd pressing: | 6 | | | | mm |
| thickness/TC | 6.1 | | | | mW/mK |

Foam I is a rigid polyurethane foam which had been produced on a double belt. Foam II is a rigid polyurethane foam which had been produced as a slabstock foam.

1. A process for producing vacuum insulation panels by envelopment of a shaped body comprising open-celled foam with a gastight film and subsequent evacuation and gastight welding shut of the film, wherein the shaped body comprising open-celled foam is compressed after curing and before evacuation.

2. The process according to claim 1, wherein the open-celled foam is a rigid polyurethane foam.

3. The process according to claim 1, wherein the open-celled foam is compressed in one stage.

4. The process according to claim 1, wherein the open-celled foam is compressed in at least two stages.

5. The process according to claim 1, wherein the compaction calculated as panel thickness before pressing:panel thickness after pressing is in the range from 2 to 3.8.

6. The process according to claim 1, wherein the compaction calculated as panel thickness before pressing:panel thickness after pressing is in the range from 3 to 3.5.

7. A vacuum insulation panel comprising a shaped body comprising open-celled rigid foam which is packed in a gastight film, evacuated and welded in so as to be airtight, wherein the open-celled rigid polyurethane foam is compressed after curing and before evacuation.
